(19) United States
(12) Patent Application Publication
(10) Pub. No.: US 2015/0224402 A1
(43) Pub. Date: Aug. 13, 2015

(54) GAME BOT DETECTION APPARATUS AND METHOD

(71) Applicant: ELECTRONICS AND TELECOMMUNICATIONS RESEARCH INSTITUTE, Daejeon (KR)

(72) Inventors: Seong-Il YANG, Daejeon (KR); Hun-Joo LEE, Daejeon (KR)

(21) Appl. No.: 14/615,688

(22) Filed: Feb. 6, 2015

(30) Foreign Application Priority Data
Feb. 10, 2014 (KR) 10-2014-0014889

(51) Int. Cl. A63F 13/75; A63F 13/79; G06F 17/30

(52) U.S. Cl. CPC A63F 13/75; G06F 17/30654; A63F 13/79

(57) ABSTRACT

Disclosed herein is a game bot detection apparatus and method. The game bot detection apparatus delivers a natural language query to a game user and determines whether the game user uses a game bot, based on expression of a response to the natural language query, received from the game user so as to determine whether the game user uses the game bot. The game bot detection apparatus includes a query generation unit for generating a natural language query to be provided to the game user. A keyword extraction unit receives expression of a response to the natural language query, input by the game user, and extracts a keyword from the response expression. An association analysis unit analyzes an association between the natural language query and the keyword, and determines whether the game user uses a game bot, based on results of analysis of the association.

### CROSS REFERENCE TO RELATED APPLICATION

This application claims the benefit of Korean Patent Application No. 10-2014-0014889 filed Feb. 10, 2014, which is hereby incorporated by reference in its entirety into this application.

### BACKGROUND OF THE INVENTION

1. Technical Field

The present invention relates generally to a game bot detection apparatus and method and, more particularly, to a game bot detection apparatus and method, which use natural language queries in an online game in which a large number of game users participate.

2. Description of the Related Art

To detect illegal users in an online game environment, various methods have been proposed. Here, illegal users participating in an online game denote, for example, users who use a game bot program for automatically acquiring items or money in the game. Representative detection methods for detecting such an illegal user include a method for determining whether a program or network packet is forged or falsified, a method for allowing an operator who personally participates in a game to access a game user who plays the game, and determining whether the user uses a game bot, and a method for analyzing the activity log data of the game user and determining whether the log data indicates a behavior pattern made by a real person.

However, it is fundamentally very difficult to distinguish the activities of a person and a game bot from each other using the above-described methods. That is, such a method adopts a configuration in which, for game characters playing a game, activity log data or network packet information is analyzed, thus making it very difficult to distinguish the activity of a person from that of a game bot based on the data or information. More specifically, in order to distinguish the activity of a person from that of a game bot using conventional methods, a procedure in which a game operation manager primarily selects suspicious users and secondarily identifies a final suspicious user is performed. However, in the case of services in which a large number of users are participating, the number of suspicious users is excessively large, or many missing cases are present due to a failure in detection, and thus it is impossible to individually cope with a larger number of suspicious users at the present time.

Further, conventional game bot detection technology distinguishes an automation program from a person by analyzing the log information of a game user, or game data such as network packets. However, even in the case of existing technology capable of desirably detecting a game bot in the past, a problem arises in that, when game data is forged or falsified in conformity with a given method, the detection of a game bot may be impossible. Similarly, methods of detecting a game bot using queries to prepared responses as in the case of a random number table are disadvantageous in that the detection of a game bot is impossible when a game bot program is improved to make prepared responses.

Furthermore, as described above, a game operator approaches a suspicious user who accesses a game and determines whether the suspicious user is a real person via conversation with the suspicious user in order to finally determine whether the corresponding user uses a game bot. However, conventional technology based on such identification and determination is disadvantageous in that, depending on the scale of a game and the number of users who participate in the game, a procedure of allowing the game operator to individually approach and identify suspicious users is inconvenient and inefficient.

In relation to this, U.S. Patent Application Publication No. 2013-0227642 discloses technology entitled “Apparatus and Method for Detecting Illegal User.” This U.S. Patent Application Publication No. 2013-0227642 describes a technique for detecting an illegal user using log data. However, as described above, the detection technique using log data is problematic in that it is very difficult to determine an illegal user.

### SUMMARY OF THE INVENTION

Accordingly, the present invention has been made keeping in mind the above problems occurring in the prior art, and an object of the present invention is to provide a game bot detection apparatus and method, which can efficiently and precisely detect an illegal user who uses a game bot program in an online game.

In accordance with an aspect of the present invention to accomplish the above object, there is provided a game bot detection apparatus, the apparatus being configured to deliver a natural language query to a game user and determine whether the game user uses a game bot, based on expression of a response to the natural language query, received from the game user so as to determine whether the game user uses the game bot, including a query generation unit for generating a natural language query to be provided to the game user; a keyword extraction unit for receiving expression of a response to the natural language query, input by the game user, and extracting a keyword from the response expression; and an association analysis unit for analyzing an association between the natural language query and the keyword, and determining whether the game user uses a game bot, based on results of analysis of the association.

The query generation unit may generate the natural language query by combining a query template stored in a query scenario storage unit with a query word stored in a language semantic storage unit.

The association analysis unit may determine whether the game user uses the game bot by analyzing an association between the query word and the keyword.

The keyword extraction unit may analyze morphemes from the response expression based on division of parts of speech.

The keyword extraction unit may determine a noun extracted by analyzing the morphemes from the response expression to be the keyword.

The association analysis unit may be configured to, if it is determined that an association between the natural language query and the keyword is not present, record suspicion information for the game user and transmit the suspicion information to a game operator.

In accordance with another aspect of the present invention to accomplish the above object, there is provided a game bot detection method using a game bot detection apparatus, the apparatus being configured to deliver a natural language query to a game user and determine whether the game user uses a game bot, based on expression of a response to the natural language query, received from the game user so as to determine whether the game user uses the game bot, the game bot detection method including generating, by a query generation unit, a natural language query to be provided to the game user; receiving, by a keyword extraction unit, expression of a response to the natural language query, input by the game user, and extracting, by the keyword extraction unit, a keyword from the response expression; and analyzing, by an association analysis unit, an association between the natural language query and the keyword, and determining, by the association analysis unit, whether the game user uses a game bot, based on results of analysis of the association.

Generating the natural language query may be performed by combining a query template stored in a query scenario storage unit with a query word stored in a language semantic storage unit.

Determining whether the game user uses the game bot may be performed by analyzing an association between the query word and the keyword.

Extracting the keyword from the response expression may include analyzing morphemes from the response expression based on division of parts of speech.

Extracting the keyword from the response expression may include determining a noun extracted by analyzing the morphemes from the response expression to be the keyword.

Determining whether the game user uses the game bot may include if it is determined that an association between the natural language query and the keyword is not present, recording suspicion information for the game user and transmitting the suspicion information to a game operator.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram showing a game bot detection system according to an embodiment of the present invention;

FIG. 2 is a flow diagram showing an embodiment in which a game bot is detected using a game bot detection apparatus according to the present invention; and

FIG. 3 is a flowchart showing a game bot detection method according to an embodiment of the present invention.

### DESCRIPTION OF THE PREFERRED EMBODIMENTS

The present invention is described in detail below with reference to the accompanying drawings. Repeated descriptions and descriptions of known functions and configurations which have been deemed to make the gist of the present invention unnecessarily obscure will be omitted below. The embodiments of the present invention are intended to fully describe the present invention to a person having ordinary knowledge in the art to which the present invention pertains. Accordingly, the shapes, sizes, etc. of components in the drawings may be exaggerated to make the description clear.

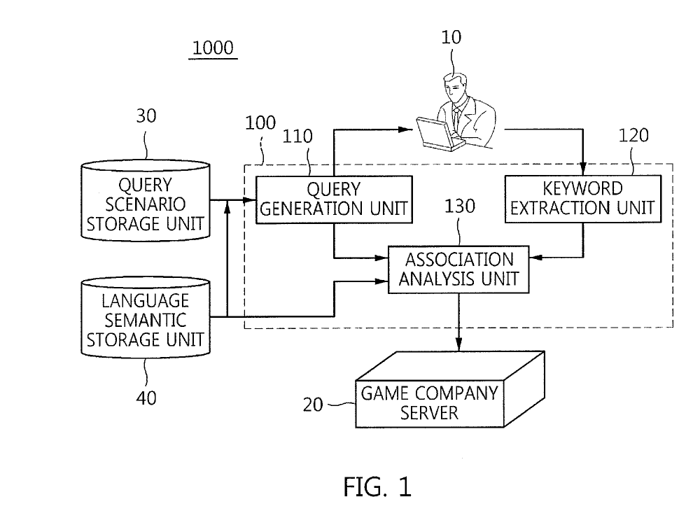

Hereinafter, a game bot detection apparatus 100 according to an embodiment of the present invention will be described in detail with reference to FIG. 1. FIG. 1 is a block diagram showing a game bot detection system 1000 according to an embodiment of the present invention. The game bot detection system 1000 according to the embodiment of the present invention determines, using the game bot detection apparatus 100, whether a game user 10 uses a game bot, and transmits suspicion information for a user determined to use a game bot to a game company server 20.

The game bot detection apparatus 100 according to the present invention functions to deliver a natural language query to a game user and to determine whether the game user uses a game bot, based on the expression of a response received from the user to the natural language query. For this, the game bot detection apparatus 100 according to the present invention may include a query generation unit 110, a keyword extraction unit 120, and an association analysis unit 130. A description of individual components included in the game bot detection apparatus 100 according to the present invention will be made in detail below.

The query generation unit 110 functions to generate a query to be provided to the game user 10. As described above, the game bot detection apparatus 100 according to the present invention delivers a natural language query to the game user 10, and determines whether the game user 10 uses a game bot, based on the expression of a response input by the game user 10. For this, the query generation unit 110 generates a query to be provided to the user by combining query templates stored in a query scenario storage unit 30 with query words stored in a language semantic storage unit 40. More specifically, the query generation unit 110 generates a query to be provided by randomly selecting one or more of multiple query templates stored in the query scenario storage unit 30 and one or more of multiple words stored in the language semantic storage unit 40. Here, the term “query” denotes a natural language query generally used by users. Below, an example in which a query is generated by the query generation unit 110 will be described.

First, the query generation unit 110 selects one or more of multiple query templates stored in the query scenario storage unit 30. Here, the term “query template” denotes the template of a query to be provided to a game user. That is, the query templates stored in the query scenario storage unit 30 may include pieces of data, such as “Please tell the words that come to your mind among NP1.” or “Do NP1 and NP2 have the same meaning?”. Here, NP1 and NP2 denote variables into which words stored in the language semantic storage unit are to be inserted.

Thereafter, the query generation unit 110 selects words, corresponding to the selected query templates, from among the multiple words stored in the language semantic storage unit 40. In the present example, it is assumed that the word “fruit” is selected from among the words stored in the language semantic storage unit 40. Here, the words in the language semantic storage unit 40 are stored together with words having a high association with each word. For this, the language semantic storage unit 40 may include a language semantic database (DB) such as ontology.

In this way, the query generation unit 110 generates a natural language query based on the query templates and the words selected from the query scenario storage unit 30 and the language semantic storage unit 40, respectively. In the present example, it is assumed that the natural language query generated by the query generation unit 110 is “Please tell the words that come to your mind among fruits.” Further, the natural language query generated in this way is delivered not only to the game user 10, but also to the association analysis unit 130, which will be described later, for subsequent association analysis.

The keyword extraction unit 120 functions to receive the expression of the response to the natural language query, input by the game user 10, and to extract a keyword from the response expression. More specifically, the keyword extraction unit 120 functions to analyze morphemes from the response expression input by the user, based on the division of parts of speech, and to extract a keyword based on the results of morpheme analysis of the response expression. That is, the keyword extraction unit 120 may determine a noun, among the morphemes extracted via the morpheme analysis, to be a keyword. Below, for easy understanding of a keyword extraction procedure, an example in which a keyword is extracted by the keyword extraction unit 120 will be described.

Assuming that the expression of a response input by the user is “I like apples”. The keyword extraction unit 120 analyzes morphemes from the input response expression. Here, when morpheme analysis is performed, the input response expression may be divided into “I (pronoun)”, “like(verb)” and “apples(noun)”. Among the parts of speech divided in this way, “apples”, that is, a noun, is determined to be the keyword. The keyword determined in this way is transferred to the association analysis unit 130.

The association analysis unit 130 functions to analyze an association between the natural language query received through the query generation unit 110 and the keyword received through the keyword extraction unit 120, and determine whether the game user uses a game bot, based on the results of the association analysis. More specifically, the association analysis unit 130 functions to determine whether the game user uses a game bot, via the analysis of an association between the query word, included in the natural language query, and the keyword.

That is, the association analysis unit 130 performs association analysis using characteristics in that words stored in the language semantic storage unit 40 and words having a high association with each word are stored together. As a result of the analysis, when a keyword extracted by the keyword extraction unit 120 is a word having a high association with the query word, the association analysis unit 130 determines that the game user does not use a game bot. Otherwise, the association analysis unit 130 determines that the game user uses the game bot, records suspicion information for the game user, and transmits the recorded suspicion information to the game company server 20, that is, a game operator.

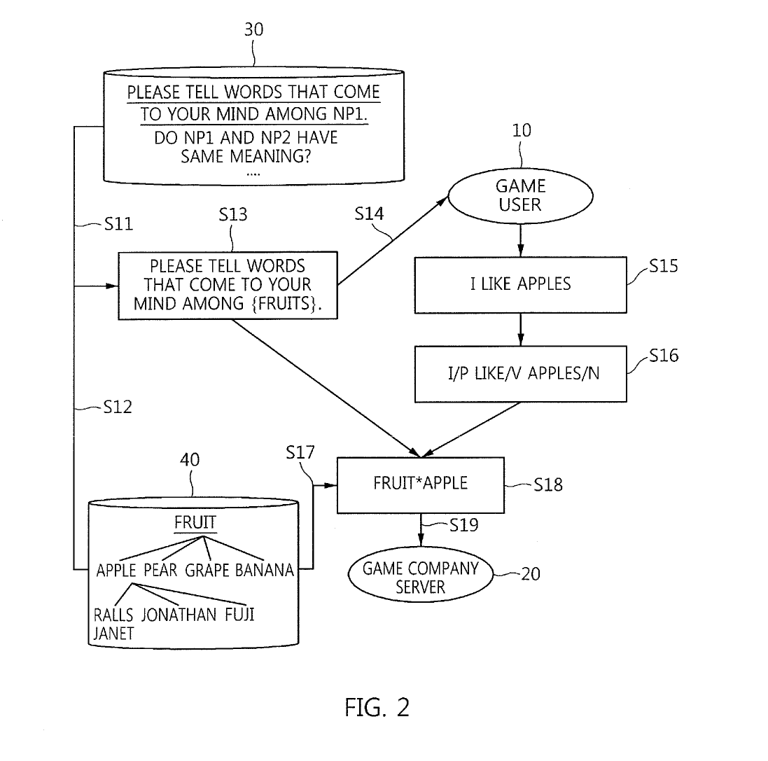

Below, an embodiment in which a game bot is detected using the game bot detection apparatus according to the present invention will be further described in detail with reference to FIG. 2. FIG. 2 is a flow diagram showing an embodiment in which a game bot is detected using the game bot detection apparatus according to the present invention.

First, by the query generation unit, one or more query templates are selected from among query templates stored in the query scenario storage unit 30 at step S11. As described above, query templates stored in the query scenario storage unit 30 may include pieces of data, such as “Please tell the words that come to your mind among NP1.” or “Do NP1 and NP2 have the same meaning?”. Here, NP1 and NP2 denote variables into which words stored in the language semantic storage unit are to be inserted. Accordingly, at step S11, one or more of the query templates are selected. In the present example, it is assumed that “Please tell the words that come to your mind among NP1.” has been selected.

Thereafter, by the query generation unit, one or more words corresponding to each query template are selected from among multiple words stored in the language semantic storage unit 40 at step S12. As described above with reference to FIG. 1, multiple words in the language semantic storage unit 40 are stored together with words having a high association with each word. That is, as shown in FIG. 2, for the word “fruit”, words having a high association, that is, apple, pear, grape, and banana, are stored together. Further, in the present example, the word selected at step S12 is assumed to be the fruit.

Once the query templates and words are selected, the query generation unit generates a natural language query based on the selected query templates and words at step S13. That is, in the present example, the natural language query generated by the query generation unit is “Please tell the words that come to your mind among fruits.” The natural language query generated in this way is transmitted to the game user and the association analysis unit at step S14.

Thereafter, the expression of a response input by the game user 10 is received at step S15. Here, it is assumed that the expression of the response input by the user 10 to the natural language query is “I like apples.”

Thereafter, by the keyword extraction unit, morphemes are analyzed from the response expression input by the user at step S16. That is, in the present example, the response expression input by the user may be divided into “I(pronoun)”, “like(verb)” and “apples(noun)”. In FIG. 2, P denotes a pronoun, N denotes a noun, V denotes a verb. If the analysis of morphemes has been completed, a keyword is extracted based on the results of analysis, and is then transferred to the association analysis unit. Here, the keyword may be extracted by extracting a noun from the response expression input by the user.

Thereafter, by the association analysis unit, an association between the natural language query received from the query generation unit and the keyword received from the keyword extraction unit is analyzed at step S18. The analysis of the association may be performed by analyzing an association between a query word included in the natural language query and the keyword, wherein the language semantic storage unit 40 is used for such analysis at step S17.

As a result of the analysis of the association, if an association between the query word and the keyword is determined to be high, it is determined that the game user does not use a game bot. Otherwise, it is determined that the game user uses a game bot, and suspicion information for the user is transmitted to the game company server 20 at step S19.

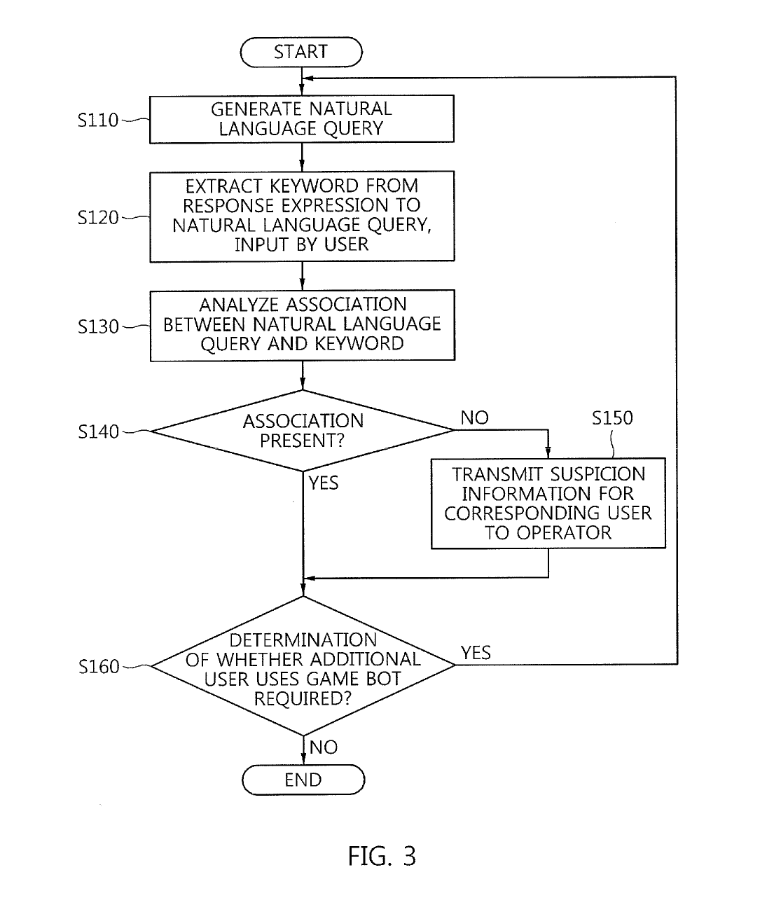

Hereinafter, a game bot detection method according to an embodiment of the present invention will be described in detail with reference to FIG. 3. FIG. 3 is a flowchart showing a game bot detection method according to an embodiment of the present invention. In the following description, redundant descriptions that have been made with reference to FIGS. 1 and 2 are omitted for clarity of description of the present specification.

In order to determine whether a game user suspected to use a game bot actually uses a game bot, a natural language query is generated by the query generation unit at step S110. More specifically, step S110 is configured such that a natural language query is generated by combining query templates stored in the query scenario storage unit with query words stored in the language semantic storage unit. Here, the term “query template” denotes the template of a query to be provided to the game user. A procedure for generating a natural language query has been described in detail with reference to FIGS. 1 and 2, and thus an additional description thereof will be omitted for the clarity of description of the present specification. Further, the natural language query generated at step S110 is transmitted to the game user and to the association analysis unit.

Thereafter, by the keyword extraction unit, the expression of a response to the natural language query, input by the user, is received, and a keyword is extracted from the response expression at step S120. As described above, the extraction of the keyword performed at step S120 may be performed by analyzing morphemes from the response expression input by the user, based on the division of parts of speech. That is, at step S120, the keyword is extracted by determining a noun extracted based on the analysis of morphemes from the response expression to be the keyword.

Then, by the association analysis unit, an association between the natural language query and the keyword is analyzed at step S130. More specifically, the analysis of the association performed at step S130 is performed between the query word included in the natural language query and the keyword extracted at step S120. For the analysis of the association, at step S130, words stored in the language semantic storage unit may be referred to. As described above, the words in the language semantic storage unit are stored together with words having a high association with each stored word.

Next, at step S140, by the association analysis unit, it is determined whether an association between the query word included in the natural language query and the keyword extracted at step S120 is present. If it is determined at step S140 that an association between the query word and the keyword is present, control proceeds to step S160; and otherwise control proceeds to step S150.

Step S150 is configured to, if it is determined at step S140 that an association between the query word and the keyword is not present, determine that the corresponding game user uses a game bot, and transmit suspicion information for the user to the game company server, that is, the game operator. When such transmission has been completed, control proceeds to step S160.

At step S160, it is determined whether the determination of whether an additional game user uses a game bot is required. As a result of the determination, if an additional game user for which additional determination is required is present, control returns to step S110, and the above-described procedures are performed again. Otherwise, control proceeds to an end block of a control flow.

In accordance with the game bot detection apparatus and method according to the present invention, there is an advantage in that a game bot is detected based on the semantic knowledge of a game user, so that detection precision for a game bot is improved, thus enabling more efficient management of online games.

The game bot detection apparatus and method according to the present invention may be implemented in the form of a program that may be executed by various computer means and may be stored in a computer-readable storage medium. The computer-readable storage medium may include program instructions, data files, and data structures solely or in combination. Program instructions recorded on the storage medium may have been specially designed and configured for the present invention, or may be known to or available to those who have ordinary knowledge in the field of computer software. Examples of the computer-readable storage medium include all types of hardware devices specially configured to record and execute program instructions, such as magnetic media, such as a hard disk, a floppy disk, and magnetic tape, optical media, such as compact disk (CD)-read only memory (ROM) and a digital versatile disk (DVD), magneto-optical media, such as a floptical disk, ROM, random access memory (RAM), and flash memory. Examples of the program instructions include machine code, such as code created by a compiler, and high-level language code executable by a computer using an interpreter. The hardware devices may be configured to operate as one or more software modules in order to perform the operation of the present invention, and the vice versa.

The teachings of principles of the present invention may be implemented by a combination of hardware and software. Furthermore, software may be implemented as an application program that is actually implemented in a program storage unit. The application program may be uploaded to a machine including a specific architecture and executed by the machine. The machine may preferably be implemented in a computer platform having hardware, such as one or more Central Processing Units (CPUs), one or more computer processors, one or more RAM devices, and one or more Input/Output (I/O) interfaces. The computer platform may further include an operating system and micro instruction code. A variety of the processes and functions described above may be part of the micro instruction code, part of an application program, or a specific combination thereof, which may be executed by various processing units including CPUs. In addition, a variety of other peripheral devices, such as an additional data storage unit and a printer, may be connected to the computer platform.

It should be additionally understood that the actual connections between system components or process function blocks may be changed depending on a scheme in which the principles of the present invention are programmed because some of the system components of the configurations and the methods illustrated in the accompanying drawings are implemented in software. If the teachings are given, those skilled in the art may take into consideration the implementations of the principles of the present invention and similar implementations or configurations.

What is claimed is:

1. A game bot detection apparatus, the apparatus being configured to deliver a natural language query to a game user and determine whether the game user uses a game bot, based on expression of a response to the natural language query, received from the game user so as to determine whether the game user uses the game bot, comprising:
a query generation unit for generating a natural language query to be provided to the game user;
a keyword extraction unit for receiving expression of a response to the natural language query, input by the game user, and extracting a keyword from the response expression; and
an association analysis unit for analyzing an association between the natural language query and the keyword, and determining whether the game user uses a game bot, based on results of analysis of the association.

2. The game bot detection apparatus of claim 1, wherein the query generation unit generates the natural language query by combining a query template stored in a query scenario storage unit with a query word stored in a language semantic storage unit.

3. The game bot detection apparatus of claim 2, wherein the association analysis unit determines whether the game user uses the game bot by analyzing an association between the query word and the keyword.

4. The game bot detection apparatus of claim 1, wherein the keyword extraction unit analyzes morphemes from the response expression based on division of parts of speech.

5. The game bot detection apparatus of claim 4, wherein the keyword extraction unit determines a noun extracted by analyzing the morphemes from the response expression to be the keyword.

6. The game bot detection apparatus of claim 1, wherein the association analysis unit is configured to, if it is determined that an association between the natural language query and the keyword is not present, record suspicion information for the game user and transmit the suspicion information to a game operator.

7. A game bot detection method using a game bot detection apparatus, the apparatus being configured to deliver a natural language query to a game user and determine whether the game user uses a game bot, based on expression of a response to the natural language query, received from the game user so as to determine whether the game user uses the game bot, the game bot detection method comprising:
generating, by a query generation unit, a natural language query to be provided to the game user;
receiving, by a keyword extraction unit, expression of a response to the natural language query, input by the game user, and extracting, by the keyword extraction unit, a keyword from the response expression; and
analyzing, by an association analysis unit, an association between the natural language query and the keyword, and determining, by the association analysis unit, whether the game user uses a game bot, based on results of analysis of the association.

8. The game bot detection method of claim 7, wherein generating the natural language query is performed by combining a query template stored in a query scenario storage unit with a query word stored in a language semantic storage unit.

9. The game bot detection method of claim 8, wherein determining whether the game user uses the game bot is performed by analyzing an association between the query word and the keyword.

10. The game bot detection method of claim 7, wherein extracting the keyword from the response expression comprises analyzing morphemes from the response expression based on division of parts of speech.

11. The game bot detection method of claim 10, wherein extracting the keyword from the response expression comprises determining a noun extracted by analyzing the morphemes from the response expression to be the keyword.

12. The game bot detection method of claim 7, wherein determining whether the game user uses the game bot comprises:
if it is determined that an association between the natural language query and the keyword is not present, recording suspicion information for the game user and transmitting the suspicion information to a game operator.
